(19) United States
(12) Patent Application Publication
(10) Pub. No.: US 2025/0332062 A1
(43) Pub. Date: Oct. 30, 2025

(54) SYSTEMS, METHODS, AND DEVICES FOR PERCUSSIVE MASSAGE THERAPY AND ASSOCIATED WELLNESS HUB

(71) Applicant: Therabody, Inc., Los Angeles, CA (US)

(72) Inventor: Jaime SANCHEZ SOLANA, Los Angeles, CA (US)

(21) Appl. No.: 19/205,634

(22) Filed: May 12, 2025

Related U.S. Application Data
(63) Continuation of application No. 18/069,841, filed on Dec. 21, 2022, now Pat. No. 12,295,900.

(51) Int. Cl. A61H 23/00; G06F 40/279; G10L 15/18; G10L 15/22; H04R 1/02; H04R 1/04; H04R 3/00

(52) U.S. Cl. CPC A61H 23/006; G06F 40/279; G10L 15/18; G10L 15/22; H04R 1/028; H04R 1/04; H04R 3/00; A61H 2201/0153; A61H 2201/1207; A61H 2201/5007; A61H 2201/5043; A61H 2201/5048; A61H 2201/5097; G10L 2015/223; H04R 2499/11

(57) ABSTRACT

Described herein are systems, methods, and devices for providing percussive massage therapy with voice activation features. A percussive massage device including a housing, a motor, a switch, a microphone, a speaker, and a controller is described. The controller of the percussive massage device includes at least one processor and a memory, and the controller is coupled to the switch, the microphone, and the speaker. The controller of the percussive massage device is configured to receive, from the microphone, a voice input of a user of the percussive massage device, perform, by the at least one processor, speech recognition of the voice input, determine, by the at least one processor, an audio output based on the speech recognition of the voice input, and transmit an audio signal to the speaker to transmit the audio output to the user of the percussive massage device.

### CROSS-REFERENCE TO RELATED APPLICATIONS

This application is a continuation of U.S. application Ser. No. 18/069,841, filed Dec. 21, 2022, the entirety of which is incorporated herein by reference.

### FIELD

Aspects of the present disclosure relate to massage devices, and particularly to components, systems, and methods for percussive massage therapy with voice activation features.

### BACKGROUND

Massage devices often provide ineffective massages that are superficial without any real benefit to users. Thus, percussive massage devices have become increasingly popular amongst users for alleviating pain and providing therapeutic relief.

In some cases, new users may be uncomfortable using percussive massage devices with which they are unfamiliar or have not used before. It may be difficult for such users to change the functions or operations of the percussive massage device if they are inexperienced with using the device or if they are unable to reach the control buttons or touch screen on the device during operation (e.g., during a massage).

### SUMMARY

Accordingly, there may be a need for providing new methods, devices, and/or systems that allow users to operate percussive massage devices using voice activation to enhance accessibility and ease of the device for users. Described herein is a percussive massage device that uses a microphone to receive voice commands or voice input from a user and a speaker to output audio to the user, including voice prompts, responses, or audio instructions. In some embodiments, the user may activate and control components of the percussive massage device by voice, such that the user may operate the device with ease and intuition. By providing voice recognition and voice control features to the percussive massage device, the overall user experience may be improved to benefit users and enhance the therapy experience.

In some embodiments, the microphone and/or speaker may be internal components or external components of the percussive therapy device and arranged within a housing of the percussive therapy device. In other embodiments, the microphone and/or speaker might not be housed within the percussive therapy device itself and may be an external microphone and/or speaker that is located in an external device (e.g., a mobile device, a smart speaker, or the like) that is communicatively coupled to the percussive therapy device.

In an embodiment, a percussive massage device including a housing, a motor, a switch, a microphone, a speaker, and a controller is described. The motor of the percussive massage device is positioned in the housing, and switch is configured to operate the motor. The controller of the percussive massage device includes at least one processor and a memory, and the controller is coupled to the switch, the microphone, and the speaker. The controller of the percussive massage device is configured to receive, from the microphone, a voice input of a user of the percussive massage device, perform, by the at least one processor, speech recognition of the voice input, determine, by the at least one processor, an audio output based on the speech recognition of the voice input, and transmit an audio signal to the speaker to transmit the audio output to the user of the percussive massage device.

In another embodiment, a percussive massage device including a housing, a motor positioned in the housing, a switch configured to operate the motor, and a controller is described. The controller includes at least one processor and a memory, and the controller is coupled to the switch, a microphone, and a speaker. The controller is configured to receive, from the microphone, a voice input of a user of the percussive massage device, perform, by the at least one processor, speech recognition of the voice input, determine, by the at least one processor, an audio output based on the speech recognition of the voice input, and transmit an audio signal to the speaker to transmit the audio output to the user of the percussive massage device.

In another embodiment, an example method of use is described. The method includes obtaining a percussive massage device comprising a housing, a motor positioned in the housing, a switch configured to operate the motor, a microphone, a speaker, and a controller, wherein the controller is coupled to the switch, the microphone, and the speaker, wherein the housing includes first, second, and third handle portions arranged to define a handle opening, and wherein the microphone and the speaker are housed in at least one of the first, second, and third handle portions. The method further includes providing a voice input to the microphone of the percussive massage device, wherein the speaker of the percussive massage device is configured to transmit an audio output and perform an action in response to the voice input, and grasping the first, second, or third handle portions and massaging a body part during or after the percussive massage device performs the action.

In another embodiment, another example method is described. The method includes receiving, at a microphone of a percussive massage device, a voice input from a user of the percussive massage device. The percussive massage device includes a housing, a motor positioned in the housing, a switch configured to operate the motor, the microphone, a speaker, and a controller, in which the controller is coupled to the switch, the microphone, and the speaker. The method further includes performing, by the controller, speech recognition of the voice input, determining, by the controller, an audio output based on the speech recognition of the voice input, and transmitting an audio signal to the speaker to transmit the audio output to the user of the percussive massage device.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the pertinent art to make and use the disclosure.

FIG. 1 illustrates an example diagram of a percussive massage device with voice activation, according to embodiments of the present disclosure.

FIG. 2 illustrates an example block diagram showing interconnected components of a percussive massage device with voice activation, according to embodiments of the present disclosure.

FIG. 3 illustrates an example diagram of a system for voice-activated percussive therapy with a percussive massage device and a mobile device, according to embodiments of the present disclosure.

FIG. 4 illustrates an example method for controlling a percussive massage device based on voice activation, according to embodiments of the present disclosure.

FIG. 5 is an example flowchart showing a method for voice activation features, according to embodiments of the present disclosure.

FIG. 6 illustrates a block diagram of example components of a computer system, according to embodiments of the present disclosure.

Embodiments of the present disclosure will be described with reference to the accompanying drawings.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment might not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, or hardware (such as one or more of a circuit, microchip, and device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Aspects of the present disclosure are directed to a percussive massage device with voice activation features. The percussive massage device may utilize voice activation components that may be attached thereto or housed within the percussive massage device, or externally coupled to the percussive massage device through an external device. In some embodiments, the voice activation components may include a microphone and a speaker. The voice activation features described herein may be used with the percussive massage devices disclosed in U.S. Patent Publication No. 2021/0244611 (“the '611 publication”), which is a publication of U.S. application Ser. No. 17/244,278, filed Apr. 29, 2021, U.S. Patent Publication No. 2021/0022955 (“the '955 publication”), which is a publication of U.S. application Ser. No. 17/066,230, filed Oct. 8, 2020, and U.S. Patent Publication No. 2020/0352821 (“the '821 publication”), which is a publication of U.S. application Ser. No. 16/824,328, filed Mar. 19, 2020, the disclosures of which are each incorporated by reference herein in their entireties.

It will be appreciated that the terms percussive massage device and percussive therapy device may be used interchangeably throughout. The terms are synonymous and generally have the same meaning. Commercial embodiments of the applicant's devices are generally being called percussive therapy devices in the market and therefore this term is used therein.

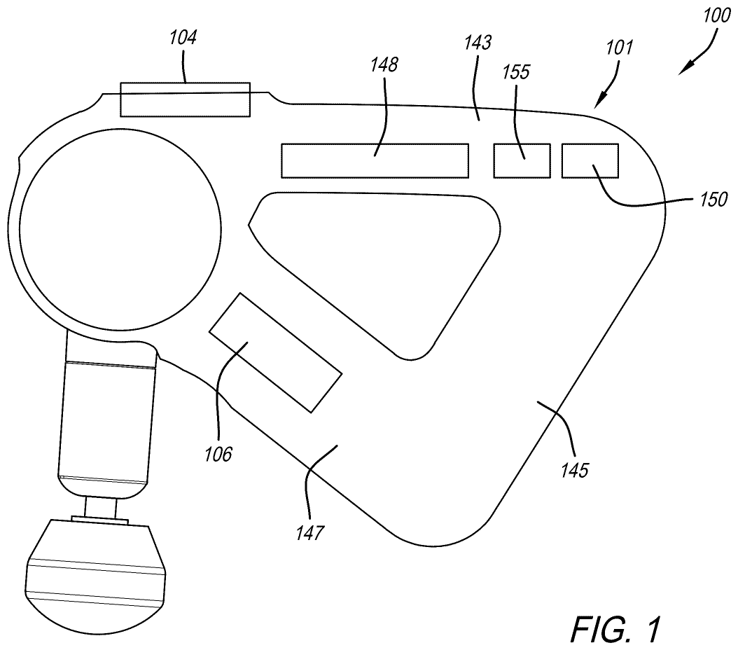

FIG. 1 illustrates an example diagram of a percussive massage device 100 with voice activation, according to embodiments of the present disclosure. The percussive massage device 100 includes a housing 101, a motor 106 positioned in the housing 101, a switch 104 configured to operate the motor 106, a microphone 150, a speaker 155, and a controller 148. The percussive massage device 100 may include similar features as the percussive massage devices disclosed in the '611 publication, the'955 publication, and/or the '821 publication.

The housing 101 of the percussive massage device 100 includes three handle portions, referred to herein as a first handle portion 143, a second handle portion 145, and a third handle portion 147. The first, second, and third handle portions 143, 145, and 147 may be arranged to define a handle opening. The first, second, and third handle portions 143, 145, and 147 may each define a corresponding axis, in each the three axes cooperate to form a triangle, as shown in FIG. 1.

The motor 106 may be connected to a reciprocating shaft or push rod assembly that is configured to reciprocate in response to activation of the motor. An attachment may be operatively connected to a distal end of the reciprocating shaft or push rod assembly and configured to provide a therapeutic effect to a user.

The switch 104 may be configured to operate the motor 106. In some embodiments, the switch 104 may be configured to turn on and turn off the percussive massage device 100 and control delivery of power to the motor 106. The switch 104 may be an electrical switch configured to allow passage of electric current when activated. In some embodiments, the switch 104 is a binary on/off switch. In another embodiment, the switch 104 is a variable switch. A variable switch controls the amount of power delivered to the motor 106. A relatively high amount of power delivered to the motor 106 by the variable switch 104 results in an increased speed of the motor 106. A relatively low amount of power delivered to the motor 106 by the variable switch 104 results in a decreased speed of the motor 106. In some embodiments, the variable switch 104 includes a variable resistor that allows a progressively increased amount of power to flow to the motor 106 in response to a progressively increasing activation of that switch 104.

The controller 148 may comprise a microcontroller unit (MCU) that is configured to control the functions of the percussive massage device 100, including the voice activation features. In some embodiments, the controller 148 may include at least one processor and a memory. In some embodiments, the memory of the controller 148 may be configured to store machine-readable code for processing by the at least one processor. Various other configurations may exist depending on whether the designer of the percussive massage device 100 desires to implement the machine-readable code in software, firmware, or both. In some embodiments, the machine-readable code is stored on the memory and configured to be executed by at least one processor of the controller 148. In some embodiments, the machine-readable code is stored on non-transitory computer-readable media.

The controller 148 may be communicatively coupled to motor 106, the switch 104, the microphone 150, the speaker 155, and other components or control units within the housing 101 of the percussive massage device 100. In some embodiments, the controller 148 may also be communicatively coupled with one or more external devices, such as a personal digital assistant, desktop workstation, laptop or notebook computer, netbook, tablet, smart phone, mobile phone, smart watch or other wearable, or any combination thereof. The controller 148 may be configured to communicate with external devices through one or more of the Internet, cable networks, cellular networks, wireless networks (e.g., Bluetooth, Wi-Fi, cellular, etc.) and wired networks. In some embodiments, the percussive massage device 100 may include a network interface that allows the device 100 to communicate with other devices through Bluetooth, Wi-Fi, cellular, and/or the like. In some embodiments, the network interface may comprise a wireless card, a hardware component, or the like, that is configured to allow the percussive massage device 100 to communicate wirelessly over a network with various other devices.

In some embodiments, the controller 148 may include input/output peripherals. In some embodiments, the microphone 150 and the speaker 155 shown in FIG. 1 may be considered to be components of the input/output peripherals of the controller 148.

The microphone 150 may be configured to receive audio from a user of the percussive massage device 100. In some embodiments, the user of the percussive massage device 100 may provide a voice input using the microphone 150 to control or operate the percussive massage device 100. In some embodiments, the voice input may include one or more voice commands from a user requesting the percussive massage device 100 to perform a specific action or requesting for information or recommendations. For example, a user may provide voice commands such as requesting to power on and/or power off the percussive massage device 100, set up or change a speed of the motor 106 (e.g., accelerate or decelerate), set a predetermined period of time for operating the motor 106, or the like. In some embodiments, the user of the percussive massage device 100 may provide a voice input to the percussive massage device 100 requesting for information or recommendations regarding different treatment protocols or routines associated with the percussive massage device 100, which attachment to use with the percussive massage device 100 (e.g., cone, ball, dampener, etc.), which body part to treat, and the like.

The microphone 150 may receive the voice input and transmit the audio from the voice input to the controller 148 for processing, including conversion, speech recognition, and natural language processing. In some embodiments, the voice input from the user may be in any language, such as English, German, French, or any other language preferred by the user. After receiving the voice input from the microphone 150, the controller 148 may process/convert the voice input and perform speech recognition and/or natural language processing of the audio from the voice input. The controller 148 may then determine an audio output based on the speech recognition and/or natural language processing of the audio from the voice input.

The speaker 155 may be configured to receive one or more audio signals from the controller 148 to transmit the audio output. The speaker 155 may transmit the audio output accordingly to the user of the percussive massage device 100. In some embodiments, the audio output may include one or more audio instructions to a user of the percussive massage device 100, in which the audio instructions provide guidance or step-by-step instructions on how to use or operate the percussive massage device 100. In some embodiments, the controller 148 may generate a customized recommendation for use of the percussive massage device 100 based on a predetermined level of pain and a length of time associated with the pain, via user input such as indicated by the user in a voice input or via other input provided to percussive massage device 100. The controller 148 may transmit one or more audio signals to the speaker 155 to transmit the audio output with the customized recommendation In some embodiments, the customized recommendation in the audio output may include one or more instructions for attachment(s) for the user to use, instructions on how to use the attachment(s) and device 100, and a recommendation on the length of time for use of the attachment(s) coupled to the device 100. In some embodiments, the customized recommendation in the audio output may be based on third-party data collected by a recommendation engine coupled to the controller 148, as described further in the '955 publication, the disclosure of which is incorporated by reference herein in its entirety. U.S. Patent Publication No. US2022/0265507A1, which is a publication of U.S. application Ser. No. 17/678,924, filed Feb. 23, 2022, describes generating and providing recommendations and is incorporated by reference herein in its entirety.

While the microphone 150 and the speaker 155 are shown located between the first and second handle portions 143 and 145 of the housing 101 in FIG. 1, the microphone 150 and the speaker 155 may be positioned in any location within the housing 101. In some embodiments, the microphone 150 and the speaker 155 may be located near the motor head area of the percussive massage device 100.

In some embodiments, the microphone 150 and the speaker 155 may be implemented as a voice-activated speaker or a smart speaker in the percussive massage device 100. In some embodiments, the microphone 150, the speaker 155, and the controller 148 may use voice recognition to accept one or more voice commands from a user of the percussive massage device 100 and execute them accordingly in the percussive massage device 100. In some embodiments, the controller 148 may determine an action for the percussive massage device 100 to perform based on the voice recognition and/or speech recognition of the voice input from the user and transmit one or more control signals to components in the percussive massage device 100 to operate the percussive massage device 100 according to the determined action. In some embodiments, the determined action may include at least one of powering on/off the percussive massage device 100, changing or setting a speed of the motor 106, setting a predetermined period of time for operating the motor 106, and the like.

In some embodiments, a user may operate the voice activation features of the percussive massage device 100 by obtaining the percussive massage device 100, providing a voice input to the microphone 150 of the percussive massage device 100, in which the speaker 155 of the percussive massage device 100 is configured to transmit an audio output and the percussive massage device 100 performs an action in response to the voice input. The user may then grasp the first, second, or third handle portions 143, 145, 147 and massage a body part during or after the percussive massage device 100 performs the action.

By providing voice-activated commands to the percussive massage device 100, the user may operate the device with ease without having to reach for specific control buttons or switches on the device itself. The voice activation and voice control features in the percussive massage device 100 may be particularly advantageous to the user when using the device to massage areas of the body that can be hard to reach (e.g., back, shoulders, limbs, etc.).

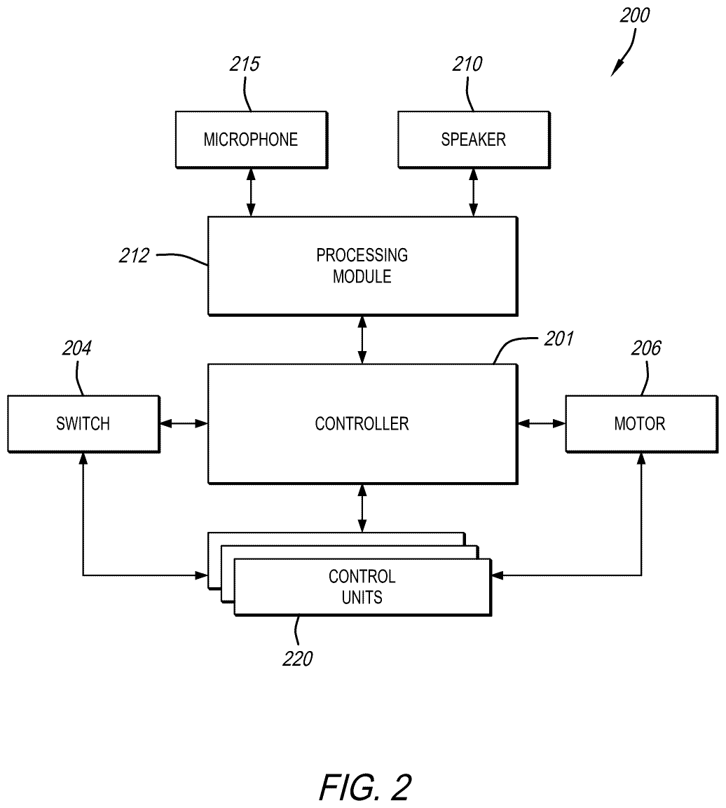

FIG. 2 illustrates an example block diagram showing interconnected components of a percussive massage device 200 with voice activation, according to embodiments of the present disclosure. Percussive massage device 200 represents an exemplary embodiment of percussive massage device 100 in FIG. 1.

Percussive massage device 200 includes controller 201, switch 204, motor 206, speaker 210, processing module 212, microphone 215, and one or control units 220. Controller 201, switch 204, motor 206, speaker 210, and microphone 215 may represent exemplary embodiments of controller 148, switch 104, motor 106, speaker 155, and microphone 150, respectively, in FIG. 1.

The controller 201 may be configured to provide one or more signals and/or communicate with each of the components in the percussive massage device 200, including the switch 204, motor 206, speaker 210, processing module 212, microphone 215, and one or control units 220.

In some embodiments, the one or more control units 220 may include at least one of an OLED (Organic Light Emitting Diodes) screen control unit, a wireless control unit, a motor drive unit, a pulse-width modulation (PWM) speed setup unit, a wireless control unit, a battery pack control unit, and a power or voltage control unit. In some embodiments, the one or more control units 220 may include additional functionality, components, units, and/or systems that are coupled to the controller (e.g., MCU) as described further in the '611 publication.

In some embodiments, the controller 201 may be coupled to a processing module 212. The processing module 212 may include one or more engines or modules that are configured to process and convert the audio from voice inputs received by microphone 215, perform speech recognition, and determine an audio output based on the speech recognition. In some embodiments, the processing module 212 may include a speech recognition module and natural language processing module configured to perform speech recognition and natural language processing, respectively, of voice inputs received from the microphone 215.

In some embodiments, the speech recognition and natural language processing modules (e.g., processing module 212) may utilize one or more machine learning algorithms including but not limited to probabilistic models, neural networks, frequency estimation, hidden Markov models, Gaussian mixture models, pattern matching algorithms, neural networks, matrix representation, Vector Quantization, or decision trees. The processing modules may utilize a machine learning algorithm to improve the accuracy of the speech recognition of received audio inputs, such as by training a machine learning model on a dataset of audio commands. In some embodiments, there may be additional steps to improve the accuracy of the model's output. For example, this may include using context information, such as the current state of the percussive massage device 100 or the user's previous commands, to help the model better understand the intended meaning of the voice commands. The use of machine learning may be particularly important for devices that perform speech recognition during actions that cause percussive massage device 100 to operate at a high volume or vibration that would make it more difficult to accurately capture audio. One example is when a user attempts to switch between different modes or settings while the percussive massage device 100 is in use. In some embodiments, the high volume or vibration of an action could interfere with microphone 215 capturing user audio. Utilizing machine learning and context information (e.g., massage intensity, massage settings) can increase the accuracy of speech recognition during these actions.

In some embodiments, the processing module 212 may perform speech recognition of the voice input by converting audio from the voice input to computer-readable text using one or more speech recognition models. The one or more speech recognition models may be stored in processing module 212 and/or in a memory of the controller 201. In some embodiments, the controller 201 may use the one or more speech recognition models and/or the code stored in the processing module 212 to perform the conversion, processing, and speech recognition steps of the voice input.

The processing module 212 may then determine the audio output by processing the computer-readable text to identify one or more words using one or more natural language processing models. The processing module 212 may then generate the audio output in response to the voice input using the one or more natural language processing models. In some embodiments, the one or more natural language processing models may be stored in processing module 212 and/or the memory of the controller 148, 201. In some embodiments, the controller 201 may use the one or more natural language processing models and/or the code stored in the processing module 212 to perform the word/voice command identification, the natural language processing, and audio generation steps for determining the audio output.

In some embodiments, the processing module 212 may train one or more speech recognition models and/or natural language models based on training data sets comprising the audio/voice commands received from a plurality of users. The training data sets may assist in improving the predictive technology used for recognizing voice commands and generating audio outputs to the user in response to the voice commands. In some embodiments, the processing module 212 may store the audio and voice command data received from the microphone 215 in a backend server (e.g., a server communicatively coupled via a network to the percussive massage device and/or an external device) for a predetermined period of time, in order to allow training and machine learning by the speech recognition models and/or natural language models. In some embodiments, the audio and voice command data stored by the backend server may be removed after the predetermined period of time.

As noted above, training of the one or more speech recognition models and/or natural language models may be optimized for the particular conditions when percussive massage device 200 is in use. Examples of these conditions include different modes or settings, such as speed, in which percussive massage device 200 may be operating when microphone 215 is utilized to receive audio input. Training may include collecting a dataset of received audio input during the different modes or settings. In some embodiments, this dataset may include a variety of different words and phrases that are commonly received during conditions. In some embodiments, percussive massage device 200 may be trained by preprocessing the collected dataset to extract features for accurately recognizing voice commands in loud environments such as denoising to remove background noise to isolate audio input.

In some embodiments, the processing module 212 may be configured to communicate with other devices, servers, wellness hubs, and the like, through a network interface of the percussive massage device 200. In some embodiments, the processing module 212 may be configured to collect data from the percussive massage device 200, including device data, user data, and biometric data. In some embodiments, device data may include data regarding the usage of the percussive massage device 200, such as run-time metrics, speeds used, force levels applied, massage attachments used, battery durations of treatment, frequency of use, and the like. This data may be used to train the one or more speech recognition models and/or natural language models for more accurate speech recognition during these particular usage conditions, as discussed above. In some embodiments, user data may include data regarding location, time, user demographics, user's language, gender, age, income, preferences, and the like. In some embodiments, biometric data may include data regarding a user's heart rate, heart rate variability (HRV), blood pressure (BP), oxygen saturation (SaO₂), sleep, body heat, body temperature, physical activity, and the like. In some embodiments, the device data, user data, and biometric data may be collected by at least one of one or more sensors associated with the percussive massage device 200, third party data providers, a wellness hub, and/or wearable devices of the user. In some embodiments, the percussive massage device 200 may collect the device data, user data, and biometric data, analyze the collected data to identify trends and/or correlations in the data, and generate recommendations based on the identified trends or correlations (e.g., through a recommendation engine).

In some embodiments, the controller 201 may be configured to initiate different treatment protocols or routines associated with the percussive massage device 200 based on the voice input received from the user. In some embodiments, the user of the percussive massage device 200 may provide a voice input (received by microphone 215) indicating a level of pain in a specific muscle or muscle group and a length of time associated with the pain. The controller 201 may determine different steps of a treatment protocol designed to target the specified muscle groups in order to provide certain therapeutic effects for the user, and the controller 201 may provide an audio output of the steps to the user via the speaker 210.

In some embodiments, the controller 201 may initiate at least one step of the protocol in which the percussive massage device 200 is configured to perform an action in response to the voice input. In some embodiments, the action comprises at least one of powering on/off the percussive massage device, changing or setting a speed of the motor, setting a predetermined period of time for operating the motor, or the like.

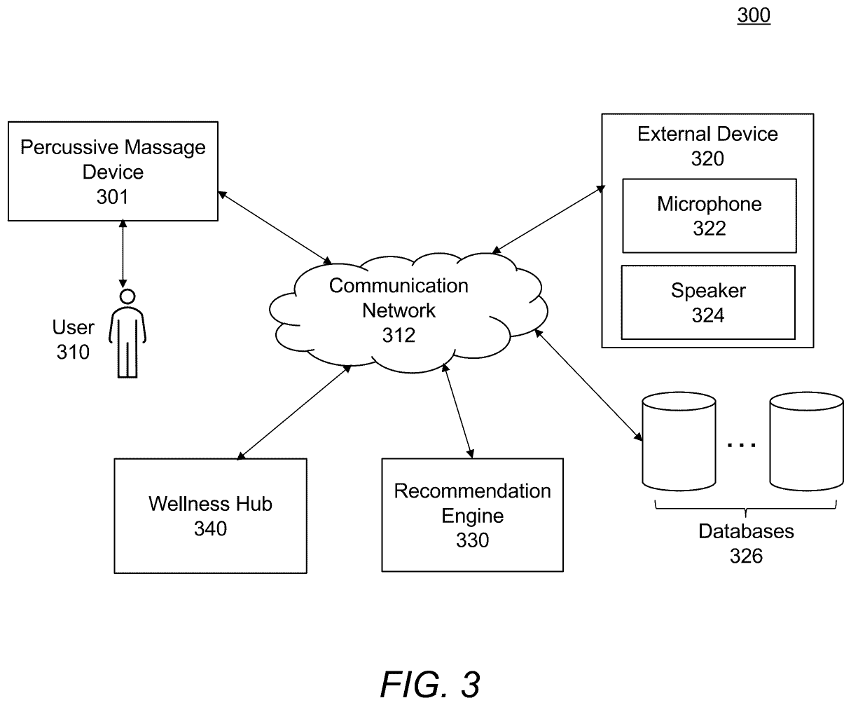

FIG. 3 illustrates an example diagram of a system 300 for voice-activated percussive therapy with a percussive massage device 301 and an external device 320, according to embodiments of the present disclosure.

System 300 includes a percussive massage device 301, a user 310 of the percussive massage device 301, an external device 320, a plurality of databases 326, a recommendation engine 330, and a wellness hub 340. Percussive massage device 301 represents an exemplary embodiment of percussive massage device 100, 200 in FIGS. 1 and 2, respectively.

The percussive massage device 301, external device 320, plurality of databases 326, recommendation engine 330, and wellness hub 340 are communicatively coupled via a communication network 312. The communication network 312 may be any one or any combination of a LAN (local area network), WAN (wide area network), WPAN (wireless personal area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols,

In some embodiments, the percussive massage device 301 may include a network interface that allows the device 301 to communicate with other devices (e.g., external device 320, plurality of databases 326, recommendation engine 330, and wellness hub 340) through Bluetooth, Wi-Fi, cellular, and/or the like. In some embodiments, the network interface may comprise a wireless card, a hardware component, or the like, that is configured to allow the percussive massage device 301 to communicate wirelessly over the communication network 312 with various other devices.

In some embodiments, the external device 320 may be a smart phone, mobile phone, personal digital assistant, desktop workstation, laptop or notebook computer, netbook, tablet, smart watch or other wearable, or any combination thereof. The external device 320 may include a microphone 322 and a speaker 324. In some embodiments, the external device 320 may be referred to as a computing device. The external device 320 may include a mobile application installed in a memory of the external device and configured to communicate with at least one of the percussive massage device 301, plurality of databases 326, recommendation engine 330, and wellness hub 340 over the communication network 312.

The wellness hub 340 may be a voice-activated and/or speech-controlled device that is configured to receive and provide voice prompts from and to the user 310. In some embodiments, the wellness hub 340 may be referred to herein as a smart home hub, a smart speaker, or the like. The wellness hub 340 may comprise one or more speakers, microphones, processors, and memory storing automatic speech recognition and/or natural language processing models for processing audio inputs and generating audio outputs to the user 310. In some embodiments, the wellness hub 340 may be located in a same room or location of the user 310, allowing the user 310 to communicate with and receive voice instructions from the wellness hub 340. The wellness hub 340 may be configured with a voice assistant technology that allows the wellness hub 340 to recognize and respond to voice commands from the user 310. The wellness hub 340 may receive audio spoken by the user 310, perform audio and speech processing, generate an audio output based on the audio and speech processing.

In some embodiments, the wellness hub 340 may be a standalone device that can operate and control the percussive massage device 301 based on voice commands from the user. In some embodiments, the wellness hub 340 may also be a charger and/or a charging dock for the percussive massage device 301. In some embodiments, the wellness hub 340 may be connected to and configured to communicate with multiple devices through the communication network 312. For example, the wellness hub 340 may be configured to communicate with and/or connect the percussive massage device 301, external device 320, the plurality of databases 326, and recommendation engine 330 over Wi-Fi. In some embodiments, the wellness hub 340 may also be connected with one or more other therapeutic devices, such as facial treatment devices, compression garments, vibrating arm sleeves, pneumatic compression boots, or any other device or wearable that is configured to provide therapeutic effect to the user 310. By receiving and processing voice prompts from the user 310, the wellness hub 340 may be configured to operate, control, and/or provide instructions to any of the therapeutic devices that are connected to the wellness hub 340 for use by the user 310.

The plurality of databases 326 may be configured to store data collected from the percussive massage device 301, user 310, wellness hub 340, and/or external device 320, such as device data, user data, and biometric data. In some embodiments, device data may include data regarding the usage of the percussive massage device 301, such as run-time metrics, speeds used, force levels applied, massage attachments used, battery durations of treatment, frequency of use, and the like. In some embodiments, user data may include data regarding location, time, user demographics, user's language, gender, age, income, preferences, and the like. In some embodiments, biometric data may include data regarding a user's heart rate, heart rate variability (HRV), blood pressure (BP), oxygen saturation (SaO₂), sleep, body heat, body temperature, physical activity, and the like.

In some embodiments, the device data, user data, and biometric data may be collected by at least one of one or more sensors associated with the percussive massage device 301, external device 320, wellness hub 340, third party data providers, and/or wearable devices of the user 310. In some embodiments, the biometric data and/or user data may be based on answers provided by the user 310 in response to one or more surveys or subjective questions prompted by the percussive massage device 301, wellness hub 340, and/or external device 320 to the user 310. For example, the percussive massage device 301, wellness hub 340, and/or external device 320 may receive audio of the user 310 in response to a question, such as “How are you feeling?” and the percussive massage device 301, wellness hub 340, and/or external device 320 may store the received audio of the user 310 as a subset of the biometric data and/or user data in one or more databases 326.

In some embodiments, one or more of the percussive massage device 301, external device 320, and/or wellness hub 340 may collect the device data, user data, and biometric data over Wi-Fi and store the collected data in one or more databases 326 of the plurality of databases 326. In some embodiments, a backend server may retrieve or access the collected data in the one or more databases 326 and analyze the collected data to identify trends and/or correlations in the data. Examples of these trends and/or correlations can be user-specific or demographic-specific. For example, the backend server may detect trends related to a single user's usage of percussive massage device 301, such as particular times or days (e.g., after the user has returned home from work or after exercising on a weekend), the user preferences for particular settings for each session, and usage metrics for each session. Trends related to a user demographic may allow recommendation engine 330 to generate recommendations based on usage and trends determined from other users in one or more common demographic categories (e.g., age, sex, level of activity, and the like). In some embodiments, the backend server may transmit the identified trends and/or correlations in the collected data with recommendation engine 330, and the recommendation engine 330 may generate recommendations based on the identified trends or correlations.

The recommendation engine 330 may be configured to receive collected device data, user data, and biometric data (e.g., from one or more databases 326 and/or the backend server) and generate recommendations regarding the use of percussive massage device 301 and/or other related therapeutic devices 101 and also which treatment protocols or routines to utilize with the one or more recommended therapeutic devices and/or percussive massage device 301. In some embodiments, based on the collected data and identified trends in the data, the recommendation engine 330 may be configured to generate multiple treatment protocols for use by the user 310 for a plurality of different days and for different therapeutic devices.

In some embodiments, the user 310 may provide voice commands to operate the percussive massage device 301 through the microphone 322 installed on the external device 320 and coupled to the mobile application operating on the external device 320. The mobile application on the external device 320 may provide the voice commands received from the microphone 322 to the controller 148, 201 or a backend server, and the controller 148, 201 or backend server may perform the speech recognition and natural language processing to provide an audio response (transmitted through the speaker 324 to the user 310) and/or activate the percussive massage device 301 to perform an action in response to the voice commands.

In some embodiments, the user 310 may provide voice commands to operate the percussive massage device 301 through the wellness hub 340. The wellness hub 340 may provide the received voice commands to the controller 148, 201 or a backend server, and the controller 148, 201 or backend server may perform the speech recognition and natural language processing to provide an audio response (transmitted through the wellness hub 340 to the user 310) and/or activate the percussive massage device 301 to perform an action in response to the voice commands.

In some embodiments, the microphone 322 and speaker 324 of the external device 320 and/or the wellness hub 340 may be utilized instead of or in addition to the microphone 150, 215 and speaker 155, 210 of the percussive massage device 301. In some embodiments, the user 310 may utilize the voice activation features of the percussive massage device 301 through any of the percussive massage device 301 itself, through the microphone 322 and speaker 324 of the external device 320 and/or through the wellness hub 340, depending on the user's preferences, such as ranking preferred voice activation components. By providing the different functionalities, the user 310 may choose which voice activation components to use according to the user's convenience. In some embodiments, percussive massage device 301 and wellness hub 340 may cooperate to determine which device (or both devices) may be used to receive the voice commands. For example, when percussive massage device 301 is in use, wellness hub 340 may be utilized instead of, or in combination with, the microphones of percussive massage device 301 to improve the accuracy of the speech recognition. In some embodiments, the decision to utilize percussive massage device 301, wellness hub 340, or both devices to perform speech recognition may occur dynamically and automatically (i.e., without user input) based on detected conditions such as usage of percussive massage device 301 and a current audio environment of both percussive massage device 301 and wellness hub 340. In some embodiments, user preferences may be given priority over any determination by percussive massage device 301 and wellness hub 340.

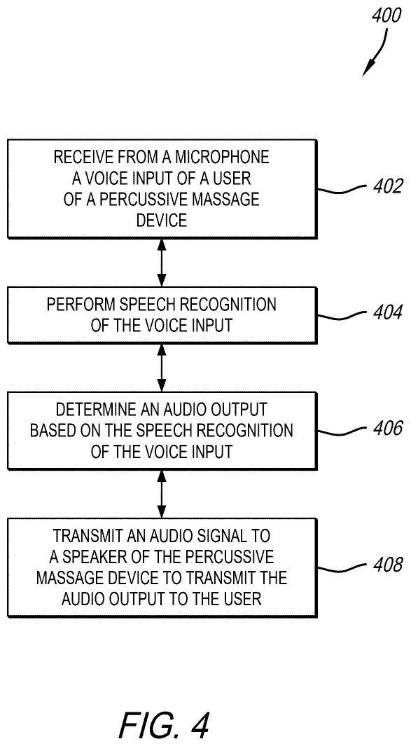

FIG. 4 illustrates an example method 400 for controlling a percussive massage device based on voice activation, according to embodiments of the present disclosure. In some embodiments, method 400 may be performed by components of the percussive massage device shown in FIGS. 1-3, as described herein. Method 400 of FIG. 4 begins with step 402 of receiving a voice input of a user of a percussive massage device. In some embodiments, the microphone 150, 215 of the percussive massage device 100, 200 may be configured to receive the voice input of the user and transmit the voice input to the controller 148, 201. In some embodiments, microphone 322 of the external device 320 and/or a microphone of the wellness hub 340 may be configured to receive the voice input of the user and transmit the voice input to a backend server communicatively coupled to external device 320 and/or the wellness hub 340. In some embodiments, determining which microphone or microphones to utilize may be based on any combination of user preferences, current usage of percussive massage device 100, 200, environmental conditions (e.g., background noise) detected by percussive massage device 100, 200, external device 320, and/or wellness hub 340, and/or recommendations provided by a machine learning model.

At step 404, speech recognition of the voice input may be performed. In some embodiments, at least one processor of the controller 148, 201 may perform speech recognition of the voice input by converting audio from the voice input to computer-readable text using one or more speech recognition models. In some embodiments, the one or more speech recognition models may be stored in processing module 212 and/or the memory of the controller 148, 201. In some embodiments, the controller 148, 201 may use the one or more speech recognition models and/or the code stored in the processing module 212 to perform the conversion, processing, and speech recognition steps of the voice input. In additional or alternative embodiments, a backend server may be configured to perform the conversion, processing, and speech recognition of the voice input to reduce the processing performed by the controller 148, 201.

At step 406, an audio output may be determined based on the speech recognition of the voice input. In some embodiments, at least one processor of the controller 148, 201 and/or a backend server may determine the audio output by processing the computer-readable text to identify one or more words using one or more natural language processing models. The at least one processor of the controller 148, 201 and/or the backend server may then generate the audio output in response to the voice input using the one or more natural language processing models. In some embodiments, the one or more natural language processing models may be stored in processing module 212, the memory of the controller 148, 201, and/or the backend server. In some embodiments, the controller 148, 201 and/or the backend server may use the one or more natural language processing models and/or the code stored in the processing module 212 to perform the word/voice command identification, the natural language processing, and audio generation steps for determining the audio output.

At step 408, an audio signal may be transmitted to a speaker to play the audio output to the user of the percussive massage device 100, 200. In some embodiments, the controller 148, 201 and/or the backend server may transmit the audio signal to at least one of the speaker 155, 210 of the percussive massage device 100, 200, speaker 324 of the external device 320, or speaker of the wellness hub 340 to transmit the audio output to the user of the percussive massage device 100, 200.

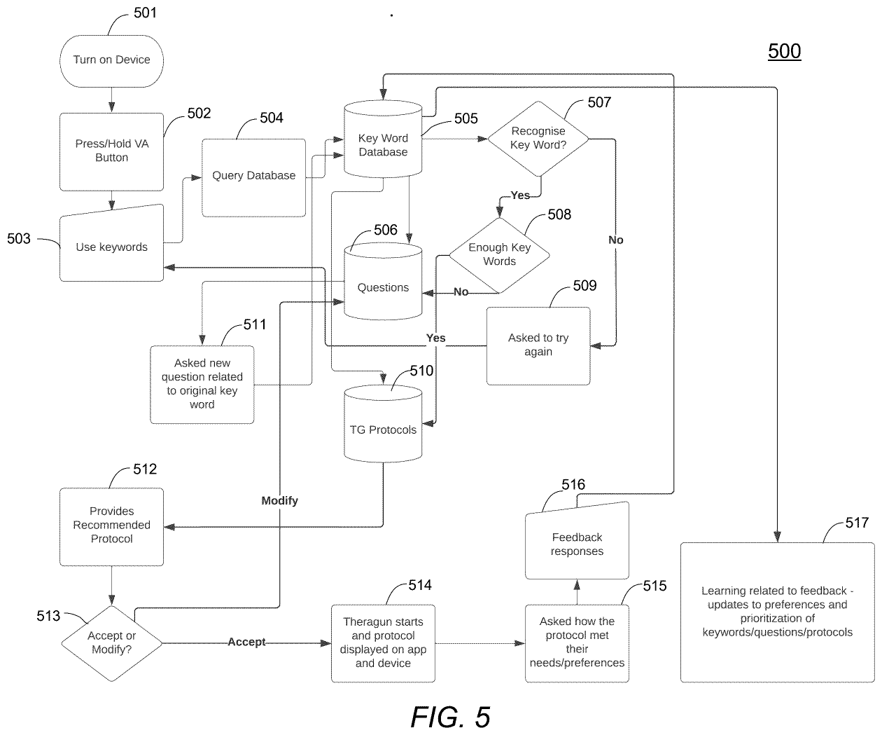

FIG. 5 is an example flowchart showing a method 500 for voice activation features, according to embodiments of the present disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that additional steps may be performed. Moreover, not all steps may be needed to perform the disclosure provided herein. Further, some of the steps may be performed simultaneously, or in a different order than shown in FIG. 5, as will be understood by a person of ordinary skill in the art. Some steps can be combined and performed as a single step. Method 500 may begin with step 501 of powering on the percussive massage device and step 502 of turning on the voice activation feature (e.g., via pressing or holding a button on the device or by a voice command). At step 503, the user of the percussive massage device may speak to the device using one or more keywords. At step 504, the device may query a keyword database 505 based on the speech input of the user.

At step 507, the device may determine if any keywords are recognized from the speech input of the user (e.g., using the processing module 212). If no keywords are recognized, the method proceeds to step 509, where the device requests the user to try again by providing another speech input. If at least one keyword is recognized, the method proceeds to step 508, where the device determines if there are enough recognizable keywords to determine a specific protocol to recommend based on the identified keywords. If there are not enough keywords to determine a specific protocol, then the method proceeds to query a questions database 506 and step 511, in which the device asks the user new questions related to the keyword identified in the original speech input provided by the user. The new questions may be predetermined by the device and may assist in obtaining more information from the user to determine which protocol to recommend for treatment. If there are enough keywords determined in step 508, then the method proceeds to query a protocols database 510 and step 512, where the device determines a protocol to recommend to the user, based on the identified keywords.

The device may provide the recommended protocol to the user, and at step 513, the device may prompt the user with an option to accept or modify the recommended protocol for using the device. If the user chooses to modify the recommended protocol, then the device will query the questions database 506 for new questions to ask the user to obtain more information from the user on which steps of the recommended protocol they would like to modify. If the user chooses to accept the recommended protocol, then the method proceeds to step 514, in which the device initiates the recommended protocol. In some embodiments, the device may initiate the recommended protocol by setting the speed to predetermined values for predetermined periods of time and providing instructions to the user through a mobile application and/or through the device. At step 515, the device may prompt the user for feedback on how the recommended protocol met the user's needs and/or preferences. At steps 516 and 517, the device may receive feedback from the user and use responses received from the user to provide a feedback loop as part of training the speech recognition model for the voice activation and speech recognition features. Based on the user feedback, the device may update one or more of the keyword database 505, questions database 506, and/or the protocols database 510 and continue improving the speech recognition and voice activation algorithms accordingly.

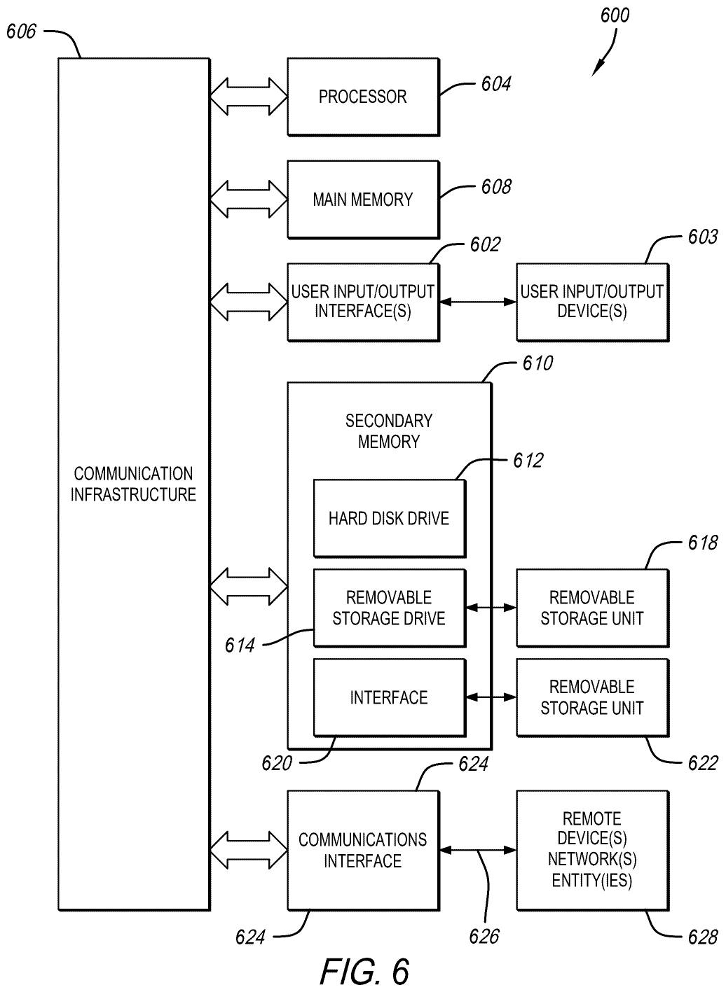

FIG. 6 is a block diagram of example components of computer system 600. One or more computer systems 600 may be used, for example, to implement any of the embodiments discussed herein, as well as combinations and sub-combinations thereof. In some embodiments, one or more computer systems 500 may be used to implement the method 400 shown in FIG. 4, method 500 shown in FIG. 5, the controller 148 shown in FIG. 1, the controller 201 shown in FIG. 2, and/or the external device 320 shown in FIG. 3, as described herein. Computer system 600 may include one or more processors (also called central processing units, or CPUs), such as a processor 604. Processor 604 may be connected to a communication infrastructure or bus 606.

Computer system 600 may also include user input/output interface(s) 602, such as monitors, keyboards, pointing devices, etc., which may communicate with communication infrastructure 606 through user input/output interface(s) 603.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data. In some embodiments, main memory 608 may include optical logic configured to perform voice activation and voice recognition features.

Computer system 600 may also include one or more secondary storage devices or memory 610. Secondary memory 610 may include, for example, a hard disk drive 612 and/or a removable storage drive 614.

Removable storage drive 614 may interact with a removable storage unit 618. Removable storage unit 618 may include a computer usable or readable storage device having stored thereon computer software (control logic) and/or data. Removable storage unit 618 may be a program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626. In some embodiments, computer system 600 may be coupled to a percussive therapy device via a wired or wireless connection through communication interface 624, including electrical wiring, pins, and/or components.

Computer system 600 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1-20. (canceled)

21. A system comprising:
a percussive massage device;
a server configured to analyze collected data and identify trends or correlations in the collected data;
a recommendation engine configured to generate recommendations based on the identified trends or correlations, wherein the recommendation engine is connected to a communication network; and
a hub comprising a standalone device configured to control the percussive massage device based on voice commands from the user, wherein the hub is configured to audibly transmit information from the server to the user, wherein the hub is configured to connect to the communication network.

22. The system of claim 21, where the hub comprises a charger for the percussive massage device.

23. The system of claim 22, wherein the hub comprises a dock for the percussive massage device.

24. The system of claim 21, wherein the collected data comprises data collected from the hub.

25. The system of claim 21, wherein the collected data comprises data collected from the percussive massage device.

26. The system of claim 21, wherein the collected data comprises data collected from multiple users.

27. The system of claim 26, wherein the collected data comprises user demographics.

28. The system of claim 26, wherein the collected data comprises user biometrics.

29. The system of claim 26, wherein the recommendation engine is configured to generate recommendations for the user based on trends determined from other users in a shared demographic category.

30. The system of claim 21, wherein the recommendations comprise multiple treatment protocols for the user.

31. The system of claim 21, wherein the recommendation engine is configured to generate recommendations for the user regarding which among multiple treatment protocols to use with the percussive massage device.

32. The system of claim 21, wherein the hub is configured to provide instructions to a second therapeutic device configured to provide a therapeutic effect to the user, wherein the second therapeutic device comprises any one or any combination of a compression garment and a vibrating sleeve.

33. The system of claim 21, wherein the hub is configured to prompt the user with questions to collect the collected data.

34. The system of claim 21, wherein the hub is configured to provide the voice commands from the user to the server, and the server is configured to perform speech recognition on the voice commands from the user.

35. A system comprising:
a percussive massage device;
a second therapeutic device configured to provide a therapeutic effect to the user, wherein the second therapeutic device comprises any one or any combination of a compression garment and a vibrating sleeve; and
a hub comprising a standalone device configured to control the percussive massage device and the second therapeutic device based on voice commands from the user.

36. The system of claim 34, wherein the hub is configured to collect usage data from the percussive massage device and the second therapeutic device and store it on a server as collected data.

37. The system of claim 35, wherein the hub is configured to provide the voice commands from the user to the server, and the server is configured to perform speech recognition on the voice commands from the user.

38. The system of claim 35, comprising a server configured to analyze the collected data and identify trends or correlations in collected data.

39. The system of claim 38, comprising a recommendation engine configured to generate multiple treatment protocols to be used with different therapeutic devices based on the identified trends or correlations.

40. The system of claim 39, wherein the different therapeutic devices comprise the percussive massage device and the second therapeutic device.
